(19) United States
(12) Patent Application Publication
(10) Pub. No.: US 2026/0312660 A1
(43) Pub. Date: Oct. 8, 2026

(54) TECHNIQUES FOR TESTING BEAMS

(71) Applicant: QUALCOMM Incorporated, San Diego, CA (US)

(72) Inventors: Bin HAN, Beijing (CN); Lu GAO, Beijing (CN); Yan LI, Beijing (CN); Yiqing CAO, Beijing (CN)

(21) Appl. No.: 19/483,856

(22) PCT Filed: Aug. 4, 2023
(86) PCT No.: PCT/CN2023/111231

§ 371 Date: Nov. 12, 2025

(51) Int. Cl. H04B 7/06; H04B 17/00; H04B 17/10

(52) U.S. Cl. CPC H04B 7/0695; H04B 17/0087; H04B 17/102

(57) ABSTRACT

Various aspects of the present disclosure generally relate to wireless communication. In some aspects, a user equipment (UE) may receive a first activation message to activate a beam lock in an anechoic chamber (AC). The UE may transmit a first completion message that indicates completion of the beam lock in the AC. The UE may receive a request for a beam identifier (ID) that is based at least in part on the beam lock. The UE may transmit the beam ID. Numerous other aspects are described.

### FIELD OF THE DISCLOSURE

Aspects of the present disclosure generally relate to wireless communication and to techniques and apparatuses for testing beams.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a first activation message to activate a beam lock in an anechoic chamber (AC). The method may include receiving a request for a beam identifier (ID) that is based at least in part on the beam lock. The method may include transmitting the beam ID.

Some aspects described herein relate to a method of wireless communication performed by a UE. The method may include receiving a first activation message to lock an antenna pattern that forms a beam towards a system simulator (SS) direction in an AC. The method may include locking a beam in a peak effective isotropic radiated power (EIRP) direction in the IFF chamber.

Some aspects described herein relate to a method of wireless communication performed by a UE. The method may include, for each direction of a plurality of specified beam directions, locking a respective beam in the direction in an RC and obtaining in-band transmit receive point (TRP) measurements of the respective beam in the RC.

Some aspects described herein relate to a method of testing wireless communication performed by a device. The method may include transmitting a first activation message to activate a beam lock in an AC. The method may include transmitting a request for a beam ID that is based at least in part on the beam lock. The method may include receiving the beam ID.

Some aspects described herein relate to a UE for wireless communication. The UE may include one or more memories and one or more processors coupled to the one or more memories. The one or more processors may be individually or collectively configured to receive a first activation message to activate a beam lock in an AC. The one or more processors may be individually or collectively configured to receive a request for a beam ID that is based at least in part on the beam lock. The one or more processors may be individually or collectively configured to transmit the beam ID.

Some aspects described herein relate to a UE for wireless communication. The UE may include one or more memories and one or more processors coupled to the one or more memories. The one or more processors may be individually or collectively configured to receive a first activation message to activate a beam lock in an IFF chamber receive a first activation message to lock an antenna pattern that forms a beam towards an SS direction in an AC. The one or more processors may be individually or collectively configured to lock a beam in a peak EIRP direction in the AC.

Some aspects described herein relate to a UE for wireless communication. The UE may include one or more memories and one or more processors coupled to the one or more memories. The one or more processors may be individually or collectively configured to, for each beam direction of a plurality of specified beam directions, lock a respective beam in the direction in an RC and obtain in-band TRP measurements of the respective beam in the RC.

Some aspects described herein relate to a device for testing wireless communication. The device may include one or more memories and one or more processors coupled to the one or more memories. The one or more processors may be individually or collectively configured to transmit a first activation message to activate a beam lock in an AC. The one or more processors may be individually or collectively configured to transmit a request for a beam ID that is based at least in part on the beam lock. The one or more processors may be individually or collectively configured to receive the beam ID.

Some aspects described herein relate to a non-transitory computer-readable medium that stores a set of instructions for wireless communication by a UE. The set of instructions, when executed by one or more processors of the UE, may cause the UE to receive a first activation message to activate a beam lock in an AC. The set of instructions, when executed by one or more processors of the UE, may cause the UE to receive a request for a beam ID that is based at least in part on the beam lock. The set of instructions, when executed by one or more processors of the UE, may cause the UE to transmit the beam ID.

Some aspects described herein relate to a non-transitory computer-readable medium that stores a set of instructions for wireless communication by a UE. The set of instructions, when executed by one or more processors of the UE, may cause the UE to receive a first activation message to lock an antenna pattern that forms a beam towards an SS direction in an AC. The set of instructions, when executed by one or more processors of the UE, may cause the UE to lock a beam in a peak EIRP direction in the IFF chamber.

Some aspects described herein relate to a non-transitory computer-readable medium that stores a set of instructions for wireless communication by a UE. The set of instructions, when executed by one or more processors of the UE, may cause the UE to, for each beam direction of a plurality of specified beam directions, lock a respective beam in the direction in an RC and obtain in-band TRP measurements of the respective beam in the RC.

Some aspects described herein relate to a non-transitory computer-readable medium that stores a set of instructions for wireless communication by a device for testing wireless communication. The set of instructions, when executed by one or more processors of the device, may cause the device to transmit a first activation message to activate a beam lock in an AC. The set of instructions, when executed by one or more processors of the device, may cause the device to transmit a request for a beam ID that is based at least in part on the beam lock. The set of instructions, when executed by one or more processors of the device, may cause the device to receive the beam ID.

Some aspects described herein relate to an apparatus for wireless communication. The apparatus may include means for receiving a first activation message to activate a beam lock in an AC. The apparatus may include means for receiving a request for a beam ID that is based at least in part on the beam lock. The apparatus may include means for transmitting the beam ID.

Some aspects described herein relate to an apparatus for wireless communication. The apparatus may include means for receiving a first activation message to lock an antenna pattern that forms a beam towards an SS direction in an AC. The apparatus may include means for locking a beam in a peak EIRP direction in the AC.

Some aspects described herein relate to an apparatus for wireless communication. The apparatus may include means for, for each beam direction of a plurality of specified beam directions, locking a respective beam in the direction in an RC. The apparatus may include means for, for each beam direction of the plurality of specified beam directions, obtaining in-band TRP measurements of the respective beam in the RC.

Some aspects described herein relate to an apparatus for wireless communication. The apparatus may include means for transmitting a first activation message to activate a beam lock in an AC. The apparatus may include means for transmitting a request for a beam ID that is based at least in part on the beam lock. The apparatus may include means for receiving the beam ID.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of testing beams using chambers, in accordance with the present disclosure.

FIG. 5 is a diagram illustrating an example associated with testing beams in a reverberation chamber (RC), in accordance with the present disclosure.

FIG. 6 is a diagram illustrating an example associated with testing beams in an RC, in accordance with the present disclosure.

FIG. 7 is a diagram illustrating an example associated with testing beams in an RC, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network entity or an apparatus of a network entity, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects relate generally to wireless communication and more particularly to testing beams for wireless communications. Some aspects more specifically relate to testing beams using test chambers. Due to the integration of radio frequency (RF) integrated circuits (RFICs) and RF front ends, over-the-air (OTA) testing is performed to characterize the performance of user equipments (UEs) that transmit millimeter wave (mmWave) beams. Testing of a wireless device, such as a UE, may include the use of an anechoic chamber (AC) that is free from echoes and reverberations. Testing methodologies in an AC may include direct far field (DFF), indirect far field (IFF), and near field to far field transform (NFTF). However, the testing times for OTA tests for mm Wave bands has been an issue. For example, testing for general spurious emissions can take one hour, and beam peak direction searches may take between 4 hours and 11 hours.

A reverberation chamber (RC) offers a fundamentally different approach to measuring complex radio systems and subsystems in an OTA environment. RCs have been used in LTE and NR FR1 OTA testing, including tests for total radiated power and total radiated sensitivity. However, RCs have not been applicable for mmW user equipment (UE) conformance testing. The issue of using an RC for transmit receive point (TRP)-based tests for mm Wave UE conformance (e.g., spurious emission, in-band TRP, etc.) is that tests are expected to measure in the in-band peak effective isotropic radiated power (EIRP) direction using a UE beam lock test function (UBF) as defined in 3GPP technical specification (TS) 38.509 (for the UE lock antenna pattern/beam in an IFF/DFF test method). However in RC testing, since there is no clear line-of-sight (LoS) path, the 3GPP-compliant test function UBF is not applicable to lock the beam at the peak EIRP direction in an RC.

According to various aspects described herein, a UE may use an AC, such as an IFF chamber, to lock a beam and obtain a beam ID for locking a beam and testing in an RC. A network entity may request the beam ID, and the UE may provide the beam ID. The network entity may activate a beam lock at the beam ID and the UE may measure in-band TRP power (power in a direction of a TRP) in the RC using a beam associated with the beam ID.

Particular aspects of the subject matter described in this disclosure can be implemented to realize one or more of the following potential advantages. In some examples, by testing a beam direction in an RC that was locked in an AC, the UE can greatly reduce the test time. For example, the testing time for measurements in a direction of a TRP in an RC is about one-tenth that of an IFF chamber.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

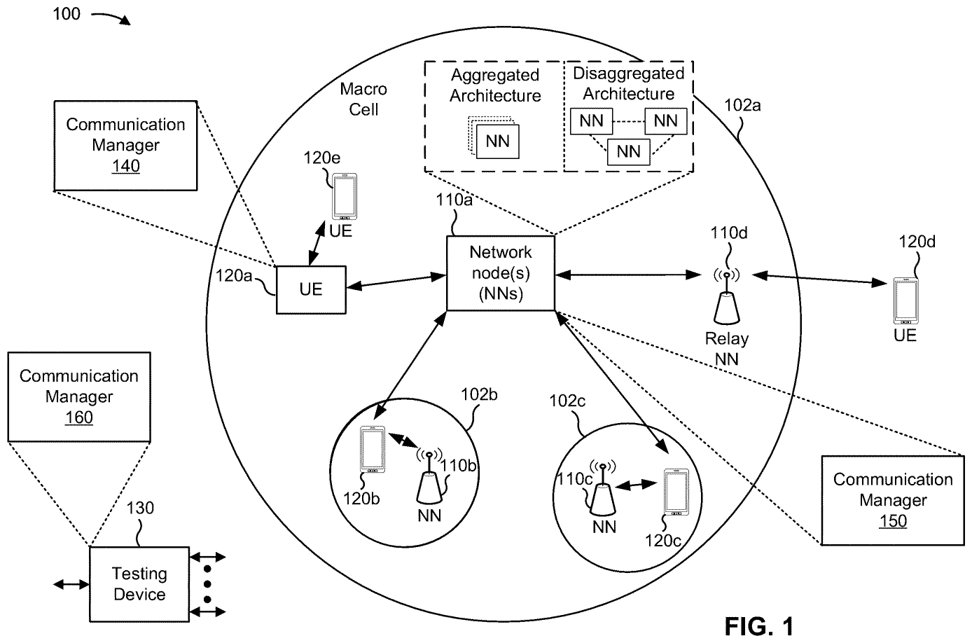

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller may couple to or communicate with a set of network nodes 110 and may provide coordination and control for these network nodes 110. The network controller may communicate with the network nodes 110 via a backhaul communication link or a midhaul communication link. The network nodes 110 may communicate with one another directly or indirectly via a wireless or wireline backhaul communication link. In some aspects, the network controller may be a CU or a core network device, or may include a CU or a core network device.

A testing device 130 may communicate with a device under test (DUT), such as a UE, and may include a simulation system for forming and receiving test signals. The testing device 130 may include, may be included in, or may otherwise be part of a testing system or testing equipment for testing beams in an AC, an RC, or another type of chamber. The testing device 130 may be part of an AC, an RC, or another type of chamber. The testing device 130 may control a turntable or other device for reorientating the DUT and changing a beam direction. The testing device 130 may be used to obtain measurements or assist the DUT with obtaining measurements. The testing device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity.

Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz- 52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., a UE 120) may include a communication manager 140. As described in more detail elsewhere herein, the communication manager 140 may receive a first activation message to activate a beam lock in an AC. The communication manager 140 may receive a request for a beam ID that is based at least in part on the beam lock. The communication manager 140 may transmit the beam ID.

In some aspects, the communication manager 140 may receive a first activation message to lock an antenna pattern that forms a beam towards a system simulator (SS) direction in an AC. The communication manager 140 may lock a beam in a peak EIRP direction in the AC.

In some aspects, the communication manager 140 may for each beam direction of a plurality of specified beam directions, lock a respective beam in the direction in an RC and obtain in-band TRP measurements of the respective beam in the RC.

Additionally, or alternatively, the communication manager 140 may perform one or more other operations described herein.

In some aspects, a device (e.g., a network node 110, a testing device 130) for testing wireless communication may include a communication manager 150 or 160. As described in more detail elsewhere herein, the communication manager 150 or 160 may transmit a first activation message to activate a beam lock in an AC. The communication manager 150 or 160 may transmit a request for a beam ID that is based at least in part on the beam lock. The communication manager 150 or 160 may receive the beam ID. Additionally, or alternatively, the communication manager 150 or 160 may perform one or more other operations described herein.

As indicated above, FIG. 1 is provided as an example. Other examples may differ from what is described with regard to FIG. 1.

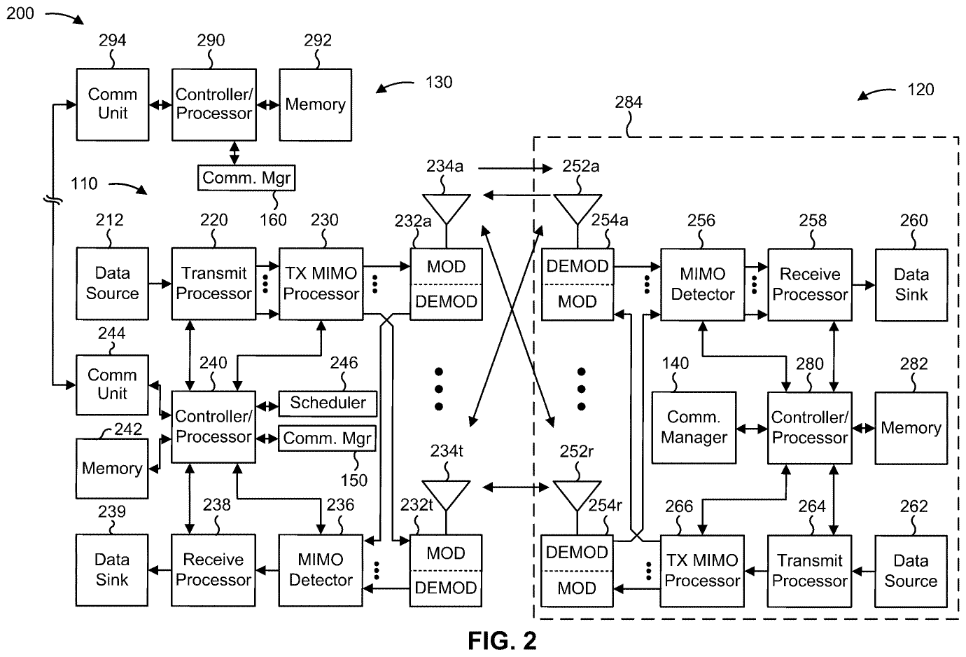

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The testing device 130 may include a communication unit 294, a controller/processor 290, and a memory 292. The testing device may include a communication manager 160 for controlling test operations. The testing device may communicate with the DUT and/or the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

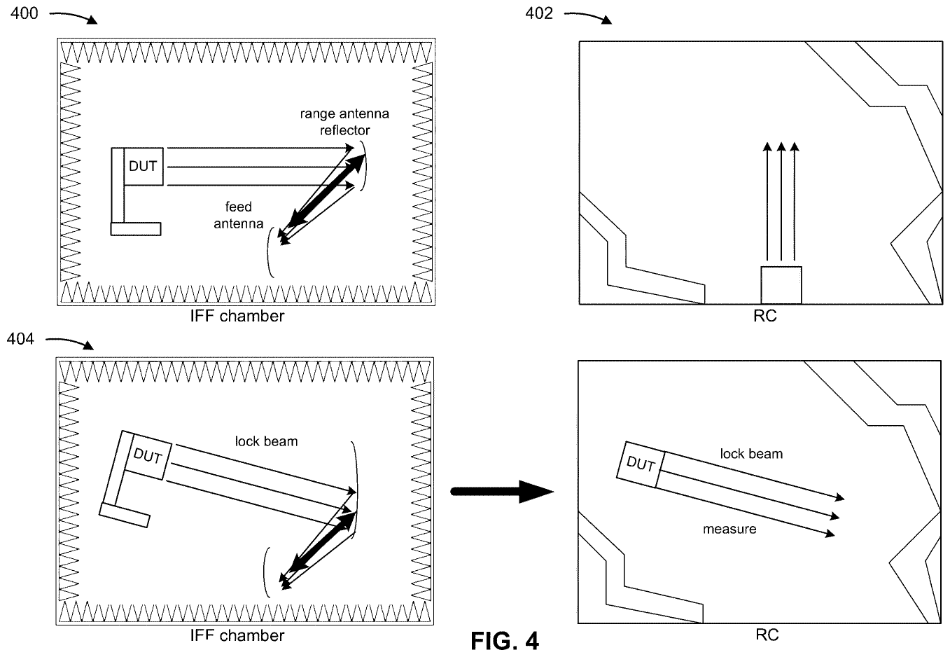

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-13).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-13).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 or controller/processor 290 may be a component of a processing system. A processing system may generally be a system or a series of machines or components that receives inputs and processes the inputs to produce a set of outputs (which may be passed to other systems or components of, for example, the network node 110 or the testing device 130). For example, a processing system of the network node 110 or the testing device 130 may be a system that includes the various other components or subcomponents of the network node 110 or the testing device 130.

The processing system of the network node 110 or the testing device 130 may interface with one or more other components of the network node 110 or the testing device 130, may process information received from one or more other components (such as inputs or signals), or may output information to one or more other components. For example, a chip or modem of the network node 110 or the testing device 130 may include a processing system, a first interface to receive or obtain information, and a second interface to output, transmit, or provide information. In some examples, the first interface may be an interface between the processing system of the chip or modem and a receiver, such that the network node 110 or the testing device 130 may receive information or signal inputs, and the information may be passed to the processing system. In some examples, the second interface may be an interface between the processing system of the chip or modem and a transmitter, such that the network node 110 or the testing device 130 may transmit information output from the chip or modem. A person having ordinary skill in the art will readily recognize that the second interface also may obtain or receive information or signal inputs, and the first interface also may output, transmit, or provide information.

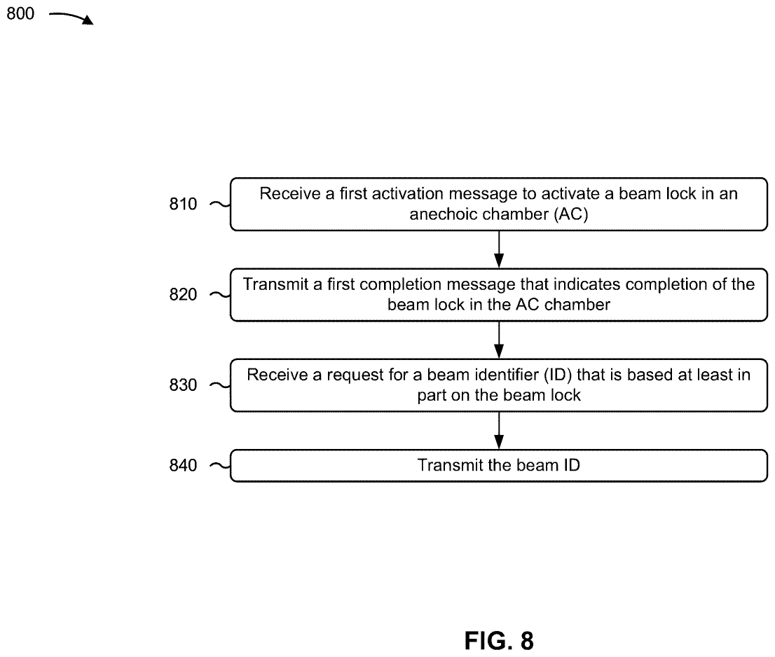

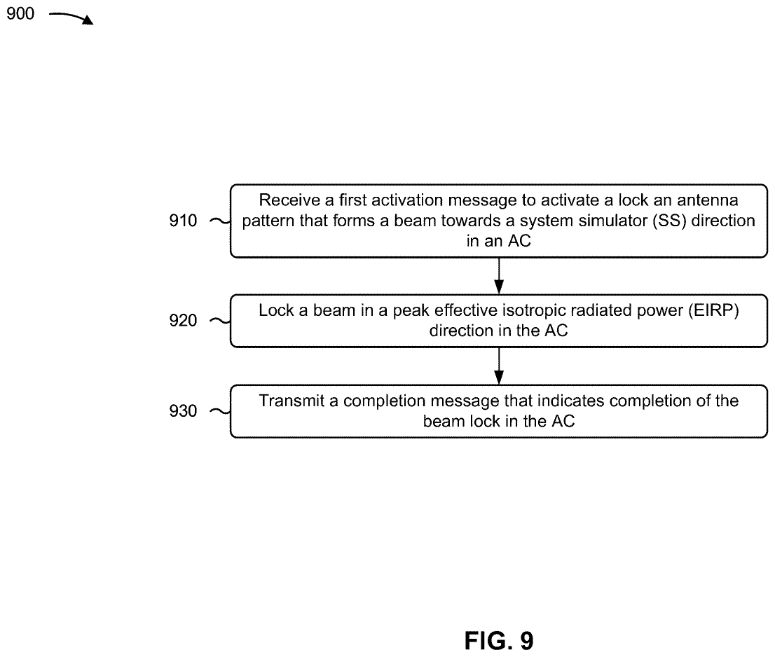

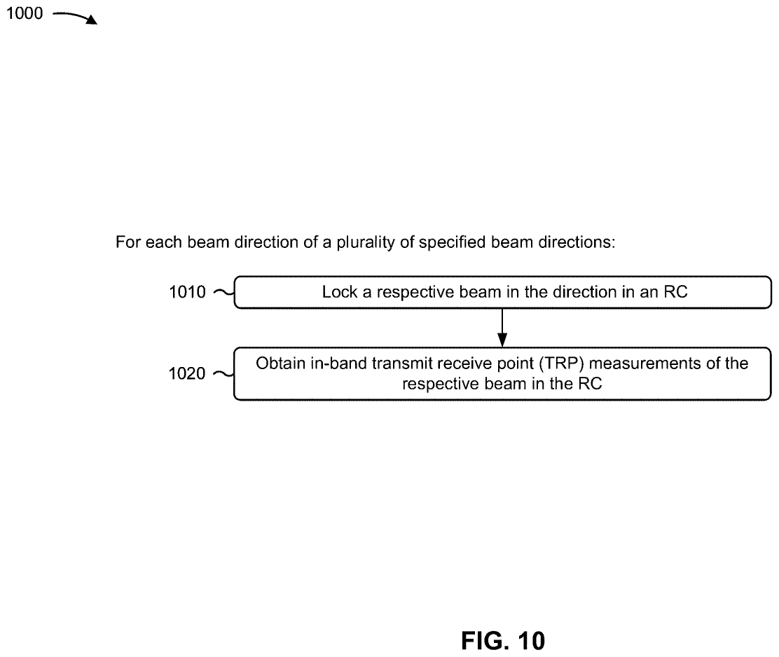

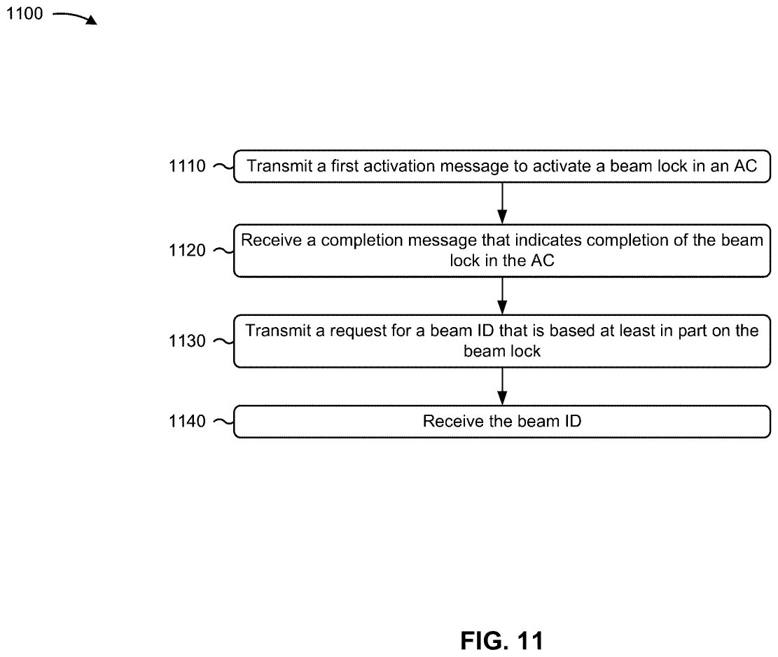

A controller/processor of a network entity (e.g., controller/processor 240 of the network node 110), the controller/processor 280 of the UE 120, the controller/processor 290 of the testing device 130, or any other component(s) of FIG. 2 may perform one or more techniques associated with testing beams, as described in more detail elsewhere herein. For example, the controller/processor 240 of the network node 110, the controller/processor 280 of the UE 120, the controller/processor 290 of the testing device 130, or any other component(s) (or combinations of components) of FIG. 2 may perform or direct operations of, for example, process 800 of FIG. 8, process 900 of FIG. 9, process 1000 of FIG. 10, process 1100 of FIG. 11, and/or other processes as described herein. The memory 242, the memory 282, and the memory 290 may store data and program codes for the network node 110, the UE 120, and the testing device 130, respectively. In some examples, the memory 242, the memory 282, and the memory 290 may include a non-transitory computer-readable medium storing one or more instructions (for example, code or program code) for wireless communication. For example, the one or more instructions, when executed (for example, directly, or after compiling, converting, or interpreting) by one or more processors of the network node 110, the UE 120, or the testing device 130, may cause the one or more processors, the network node 110, the UE 120, or the testing device 130 to perform or direct operations of, for example, process 800 of FIG. 8, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving a first activation message to activate a beam lock in an AC; means for receiving a request for a beam ID that is based at least in part on the beam lock; and/or means for transmitting the beam ID. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving a first activation message to lock an antenna pattern that forms a beam towards an SS direction in an AC; and/or means for locking a beam in a peak EIRP direction in the AC.

In some aspects, the UE includes for each beam direction of a plurality of specified beam directions, means for locking a respective beam in the direction in a RC; and/or means for obtaining in-band TRP measurements of the respective beam in the RC.

In some aspects, a device (e.g., a network node 110, a testing device 130) for testing wireless communication includes means for transmitting a first activation message to activate a beam lock in an AC; means for transmitting a request for a beam ID that is based at least in part on the beam lock; and/or means for receiving the beam ID. In some aspects, the means for the device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the device to perform operations described herein may include, for example, one or more of communication manager 160, memory 292, controller/processor 290, or communication unit 294.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

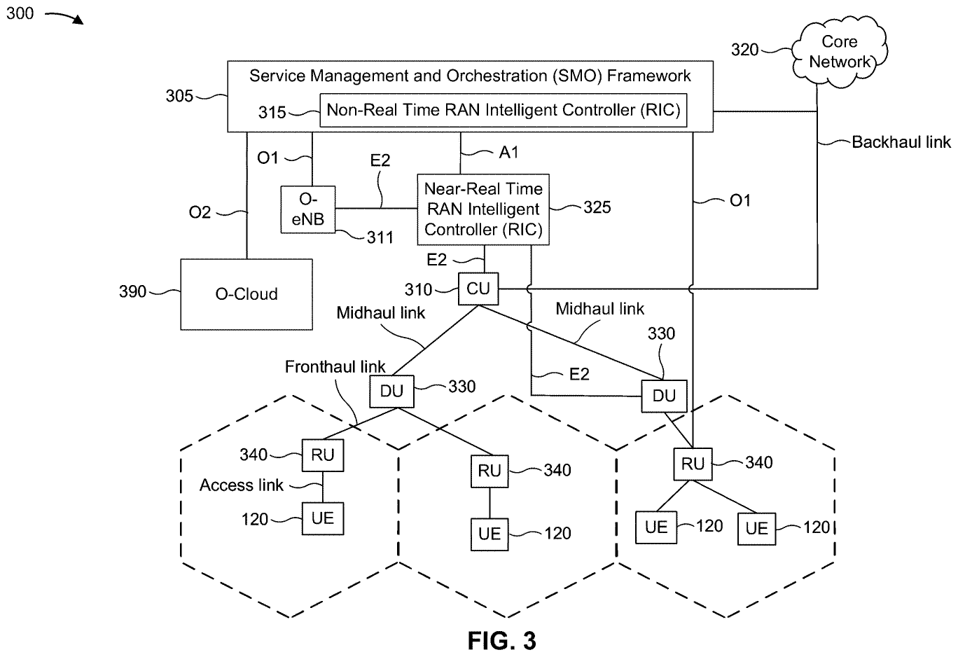

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 402, and 404 of testing beams using chambers, in accordance with the present disclosure.

Due to the integration of RFICs and RF front ends, OTA testing is performed to characterize the performance of UEs that transmit mmWave beams. Testing methodologies may include DFF, IFF, and NFTF in an AC. Example 400 shows UE beam testing in an AC, such as an IFF chamber. The IFF test method may create a far-field environment using a transformation with a parabolic reflector. This IFF test is also known as a compact antenna test range (CATR). Inside the CATR chamber, a DUT (such as a UE) radiates a wave front to a range-antenna reflector, which collimates the radiated spherical wave front into a receiver-feed antenna. The distance between the DUT and the receiver allows for the emanating spherical wave to almost reach a plane phase from the transmitter to the receiver. Measurements are taken at the receiver. In another example, in a DFF chamber, the DUT is mounted on a positioner which rotates in azimuth and elevation, allowing the object to be measured at any angle over the entire 3D sphere. The DFF method allows the most complete tests to be performed by measuring several signals. The signals may be received and directly measured from the DUT as if at a distance.

In another example, an AC may include a far-field measurement system with a distributed axis positioning system that includes an azimuth mast rotator for rotating the DUT about a phi axis and a theta ring positioner for elevating measurement horns around the DUT. Each measurement bandwidth may be covered by dedicated paths (e.g., RF cables, rectangular waveguides, measurement horns) that are associated with a common amplification stage. The AC may provide a shielded environment over a very wide frequency range (e.g., from 18 GHz to 110 GHz) and ensure stable measurement results. The system may include an antenna software suite that provides for antenna measurement (measurement control and data acquisition) and antenna viewing (post-processing and tabular/graphical data output).

The testing time for OTA tests for mmWave bands has been an issue. For example, testing for general spurious emissions can take one hour, and beam peak direction searches may take between 4 hours and 11 hours.

An RC offers a fundamentally different approach to measuring complex radio systems and subsystems in an OTA environment. Reverberation is the persistence of a signal after it has been stopped due to multiple reflections from surfaces within a closed surface. These reflections build up with each reflection and decay gradually as they are absorbed by the surfaces of objects in the enclosed space. An RC, as shown by example 402, may be a screened room with a minimum of absorption of electromagnetic energy. Due to the low absorption, very high field strength can be achieved with moderate input power. An RC may include a metallic cavity (e.g., welded aluminum) where the signal created by a single source is reflected and diffused to create multipath fading. The RC may be a cavity resonator with a high Q (quality) factor. The spatial distribution of the electrical and magnetic field strengths may be strongly inhomogeneous (standing waves). RCs have been used in LTE and NR FR1 OTA testing, including tests for total radiated power and total radiated sensitivity. However, RCs have not been applicable for mm Wave UE conformance testing. The issue of using an RC for TRP-based tests for mm Wave UE conformance (e.g., spurious emission, in-band TRP, etc.) is that tests are expected to measure in the in-band peak EIRP direction using a UBF as defined in 3GPP technical specification (TS) 38.509 (for the UE lock antenna pattern/beam in an IFF/DFF test method). However in RC testing, since there is no clear LoS path, the 3GPP-compliant test function UBF is not applicable to lock the beam at the peak EIRP direction in an RC.

According to various aspects described herein, a UE may use an IFF technique to lock a beam and obtain a beam ID for locking a beam and testing in an RC. A network entity may request the beam ID, and the UE may provide the beam ID. The network entity may activate a beam lock at the beam ID and the UE may measure in-band TRP power (power in a direction of a TRP) in the RC using a beam associated with the beam ID. Example 404 shows the locking of a beam in an AC (e.g., IFF chamber). A testing device associated with the AC in example 404 may operate a turntable to reorient the UE or change a beam direction for the UE in the AC. Example 404 also shows using the same beam direction that was locked in the AC for testing in an RC. An advantage of the RC is that testing in an RC can greatly reduce the test time. For example, the testing time for measurements in a direction of a TRP in an RC is about one-tenth that of an IFF chamber. As a result of using an RC for testing, testing time is reduced, including for cases such as spurious emissions.

In some aspects, the UE may lock a beam in a peak EIRP direction in an AC (e.g., IFF chamber, DFF chamber) and measure the in-band TRP in the locked direction in an RC. If the difference between a measurement in the AC in the locked direction and the measurement in the RC in the locked direction is within a threshold difference, the locked direction may be used for other TRP-based conformance tests.

In some aspects, the UE may lock beams in a plurality of specified directions and perform measurements in the locked directions in an RC. The UE may report the measurements if the tests in the locked directions pass an emission condition or fall back to the use of an AC, such as with IFF testing, if a direction does not pass the emission condition. An emission condition may include an emission limit or other another limit that is based at least in part on a metric of radiated power. This technique reduces the time for spurious emission tests.

By using the techniques described above in an RC, beams may be tested in less time.

As indicated above, FIG. 4 is provided as an example. Other examples may differ from what is described with regard to FIG. 4.

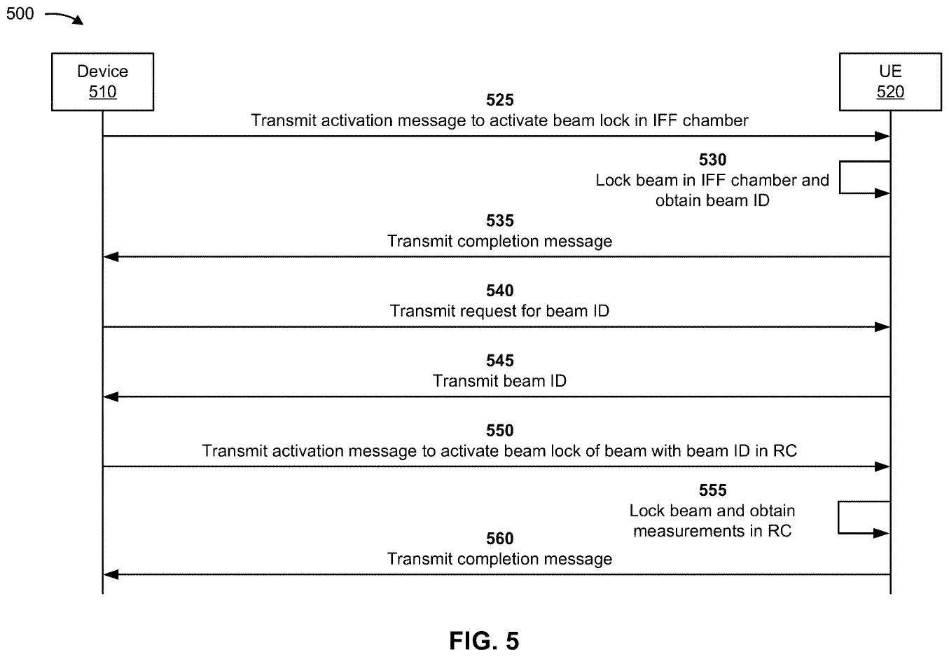

FIG. 5 is a diagram illustrating an example 500 associated with testing beams in an RC, in accordance with the present disclosure. As shown in FIG. 5, a device 510 (e.g., a network node 110, a testing device 130) and a UE 520 (e.g., UE 120) may communicate with one another via a wireless network (e.g., wireless network 100).

Example 500 shows a test function for a DUT, such as UE 520, to lock a beam to a specified beam ID. The UE 520 may use an RC to obtain TRP-based measurements (e.g., in a direction of a TRP), including measurements for spurious emission, measurements to determine an adjacent channel leakage radio (ACLR), in-band TRP measurements, and/or measurements involving a spectrum emission mask.

As shown by reference number 525, the device 510 may transmit a first activation message to active a beam lock in an AC. In example 500, the AC is an IFF chamber.

As shown by reference number 530, the UE 520 may lock a beam in an IFF chamber and obtain a beam ID of the beam. The UE 520 may be placed in an IFF chamber and run an IFF test to find a peak EIRP direction. The UE 520 may operate as configured for testing in an AC, such as an IFF chamber. The UE 520 may receive test or beam lock instructions and may beamform and transmit signals with a configuration for testing in an AC. The UE 520 may lock a beam in the peak EIRP direction. The UE 520 may obtain a beam ID for the beam. As shown by reference number 535, the UE 520 may transmit a completion message that indicates completion of the beam lock.

As shown by reference number 540, the device 510 may transmit a request for the beam ID. As shown by reference number 545, the UE 520 may transmit the beam ID. The device 510 may receive and record the beam ID.

As shown by reference number 550, the device 510 may transmit a second activation message to activate a beam lock in an RC. The beam lock is to be for a beam associated with the beam ID (beam direction indicated by the beam ID). As shown by reference number 555, the UE 520 may lock the beam associated with the beam ID in an RC and obtain measurements (e.g., in-band TRP measurements, spurious emission measurements). The UE 520 may operate as configured for testing in an RC. The UE 520 may receive test or beam lock instructions and may beamform and transmit signals with a configuration for testing in an RC. The UE 520 may obtain the measurements by measuring received or reflected signals. The UE 520 may obtain measurements via a testing system, a simulation system, or a receiver in the RC.

As shown by reference number 560, the UE 520 may transmit a completion message that indicates completion of the beam lock. The completion message may include the measurements or an indication of the measurements.

As indicated above, FIG. 5 is provided as an example. Other examples may differ from what is described with respect to FIG. 5.

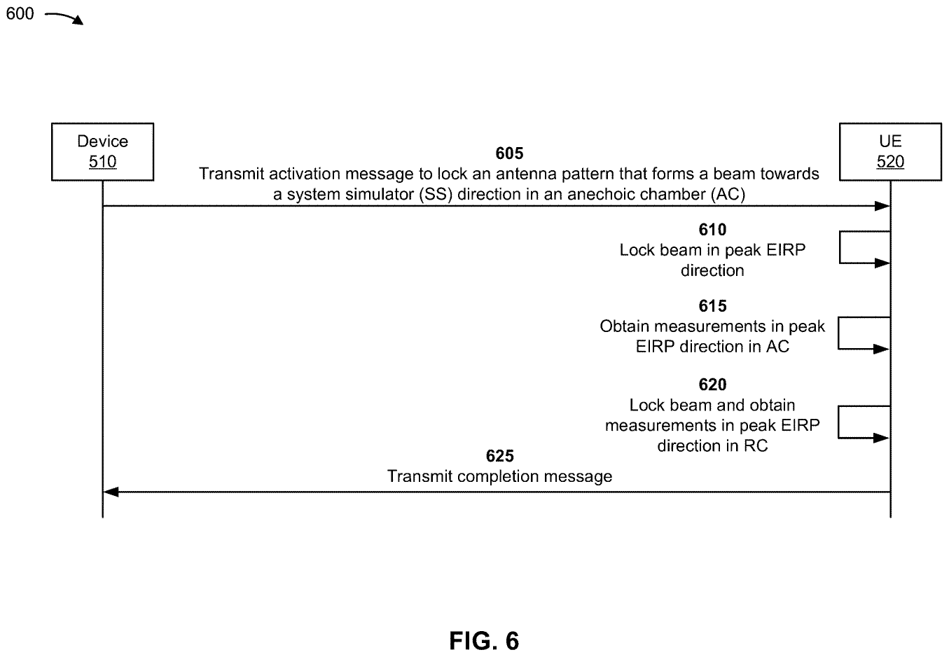

FIG. 6 is a diagram illustrating an example 600 associated with testing beams in an RC, in accordance with the present disclosure.

In some aspects, the UE 520 may select the proper test direction(s) without defining a new test function (e.g., leverage a UBF that does not involve obtaining a beam ID). For example, the UE 520 may use the in-band TRP measured in an IFF chamber as the reference to decide the test direction in an RC.

As shown by reference number 605, the device 510 may transmit a first activation message to active a beam lock in an IFF chamber. As shown by reference number 610, the UE 520 may lock a beam in a peak EIRP direction in an IFF chamber. This may include using an existing UBF. As shown by reference number 615, the UE 520 may obtain measurements (e.g., in-band TRP measurements such as power measurements) TRP_{IFF} in the peak EIRP direction in the IFF chamber.

As shown by reference number 620, the UE 520 may lock a beam in the peak EIRP direction in an RC chamber and obtain measurements (e.g., in-band TRP measurements such as power measurements) TRP_{RC}. The UE 520 may compare TRP_{IFF} and TRP_{RC}. For example, if a difference (delta) between the measurements |TRP_{RC}−TRP_{IFF} satisfies a threshold (e.g., less than or equal to a delta threshold), the peak EIRP direction can be used for other TRP-based RF conformance tests, such as a test for spurious emissions. As shown by reference number 625, the UE 520 may transmit a completion message that indicates completion of the beam lock. The completion message may include the measurements or an indication of the measurements.

If the difference does not satisfy the threshold (e.g., is greater than the delta threshold), the UE 520 may repeat the steps of reference number 620 with another test direction or another UE orientation to find a proper test direction. If no proper orientation can be found in predefined UE orientations, the test may fall back to other IFF testing.

As indicated above, FIG. 6 is provided as an example. Other examples may differ from what is described with respect to FIG. 6.

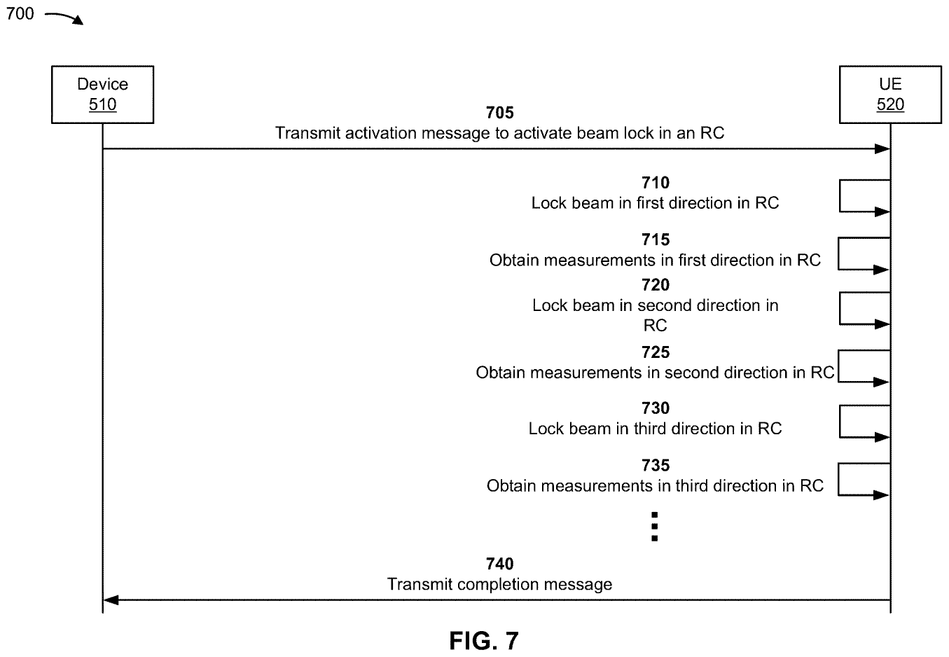

FIG. 7 is a diagram illustrating an example 700 associated with testing beams in an RC, in accordance with the present disclosure.

In some aspects, the UE 520 may select a plurality of predefined or specified beam directions in an RC to test, such as to verify UE spurious emissions. The UE 520 may lock a beam and obtain measurements for each beam direction in the plurality of specified beam directions.

As shown by reference number 705, the device 510 may transmit a first activation message to active a beam lock in an RC. As shown by reference number 710, the UE 520 may lock a beam in a first direction of the plurality of specified beam directions in the RC. As shown by reference number 715, the UE 520 may obtain measurements (e.g., for spurious emission testing) in the first direction in the RC. As shown by reference number 720, the UE 520 may lock a beam in a second direction of the plurality of specified beam directions in the RC. As shown by reference number 725, the UE 520 may obtain measurements in the second direction in the RC. As shown by reference number 730, the UE 520 may lock a beam in a third direction of the plurality of specified beam directions in the RC. As shown by reference number 735, the UE 520 may obtain measurements in the third direction in the RC. The UE 520 may continue to lock beams and obtain measurements for the rest of the plurality of specified beam directions.

The UE 520 may determine whether the UE 520 can satisfy an emission condition or pass the emission condition within a margin (set as a value ≥0). If all of the directions pass, the UE 520 may report the measurements. As shown by reference number 740, the UE 520 may transmit a completion message that indicates completion of the beam lock. The completion message may include the measurements or an indication of the measurements. If any of the beam directions fail to pass (e.g., do not satisfy the emission condition), the UE 520 may fall back into other IFF testing.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120, UE 520) performs operations associated with techniques for testing beams.

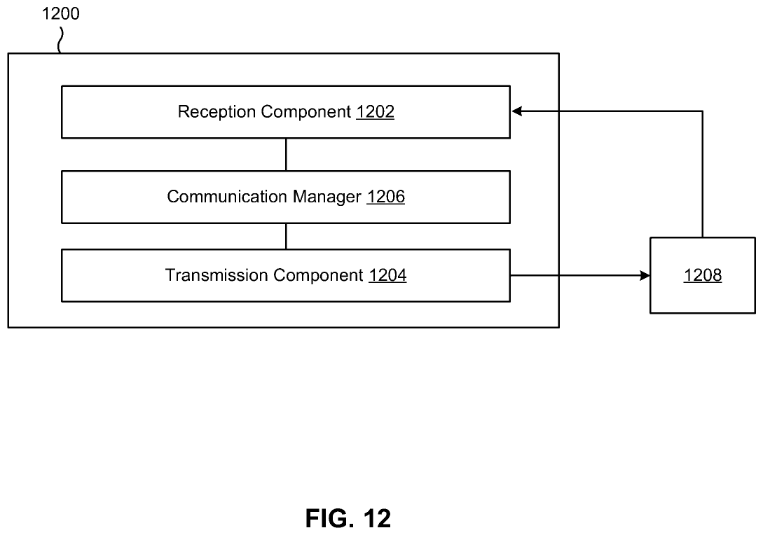

As shown in FIG. 8, in some aspects, process 800 may include receiving a first activation message to activate a beam lock in an AC (block 810). For example, the UE (e.g., using reception component 1202 and/or communication manager 1206, depicted in FIG. 12) may receive a first activation message to activate a beam lock in an AC, as described above.

As further shown in FIG. 8, in some aspects, process 800 may include receiving a request for a beam ID that is based at least in part on the beam lock (block 820). For example, the UE (e.g., using reception component 1202 and/or communication manager 1206, depicted in FIG. 12) may receive a request for a beam ID that is based at least in part on the beam lock, as described above.

As further shown in FIG. 8, in some aspects, process 800 may include transmitting the beam ID (block 830). For example, the UE (e.g., using transmission component 1204 and/or communication manager 1206, depicted in FIG. 12) may transmit the beam ID, as described above.

Process 800 may include additional aspects, such as any single aspect or any combination of aspects described below and/or in connection with one or more other processes described elsewhere herein.

In a first aspect, process 800 includes transmitting a completion message that indicates completion of the beam lock in the AC.

In a second aspect, alone or in combination with the first aspect, process 800 includes receiving a second activation message to activate a beam lock of a beam associated with the beam ID in an RC.

In a third aspect, alone or in combination with one or more of the first and second aspects, process 800 includes transmitting a completion message that indicates completion of the beam lock in the RC.

In a fourth aspect, alone or in combination with one or more of the first through third aspects, process 800 includes activating a beam lock in the AC.

In a fifth aspect, alone or in combination with one or more of the first through fourth aspects, process 800 includes obtaining a peak EIRP direction in the AC, and selecting the beam ID based at least in part on the EIRP direction.

In a sixth aspect, alone or in combination with one or more of the first through fifth aspects, process 800 includes obtaining in-band TRP measurements in a direction of a beam associated with the beam ID.

In a seventh aspect, alone or in combination with one or more of the first through sixth aspects, process 800 includes obtaining the beam ID based at least in part on signaling from a system simulator of the AC chamber.

In an eighth aspect, alone or in combination with one or more of the first through seventh aspects, the AC includes a direct far field (DFF) chamber or an indirect far field (IFF) chamber.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, a UE or an apparatus of a UE, in accordance with the present disclosure. Example process 900 is an example where the UE (e.g., UE 120, UE 520) performs operations associated with techniques for testing beams.

As shown in FIG. 9, in some aspects, process 900 may include receiving a first activation message to lock an antenna pattern that forms a beam towards an SS direction in an AC (block 910). For example, the device (e.g., using reception component 1202 and/or communication manager 1206, depicted in FIG. 12) may receive a first activation message to lock an antenna pattern that forms a beam towards an SS direction in an AC, as described above.

As further shown in FIG. 9, in some aspects, process 900 may include locking a beam in a peak EIRP direction in the AC (block 920). For example, the device (e.g., using communication manager 1206, depicted in FIG. 12) may lock a beam in a peak EIRP direction in the AC, as described above.

Process 900 may include additional aspects, such as any single aspect or any combination of aspects described below and/or in connection with one or more other processes described elsewhere herein.

In a first aspect, the AC includes a direct far field (DFF) chamber or an indirect far field (IFF) chamber.

In a second aspect, alone or in combination with the first aspect, process 900 includes transmitting a first completion message that indicates completion of a beam lock in the AC.

In a third aspect, alone or in combination with one or more of the first and second aspects, process 900 includes unlocking the antenna pattern based at least in part on expiration of a timer.

In a fourth aspect, alone or in combination with one or more of the first through third aspects, process 900 includes obtaining in-band transmit receive point (TRP) measurements of the beam in the peak EIRP direction in the AC.

In a fifth aspect, alone or in combination with one or more of the first through fourth aspects, process 900 includes obtaining in-band TRP measurements of a beam in a first direction in an RC.

In a sixth aspect, alone or in combination with one or more of the first through fifth aspects, process 900 includes performing additional testing in the first direction in the RC based at least in part on a difference between a power measurement in the peak EIRP direction and a power measurement in the first direction satisfying a difference threshold, or obtaining in-band TRP measurements of a beam in a second direction in the RC based at least in part on the difference not satisfying the difference threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE, in accordance with the present disclosure. Example process 1000 is an example where the apparatus or the UE (e.g., UE 120, UE 520) performs operations associated with techniques for testing beams.

As shown in FIG. 10, in some aspects, process 1000 may include, for each beam direction of a plurality of specified beam directions, locking a respective beam in the direction in an RC (block 1010). For example, the UE (e.g., using communication manager 1206, depicted in FIG. 12) may, for each beam direction of a plurality of specified beam directions, lock a respective beam in the direction in an RC, as described above.

As shown in FIG. 10, in some aspects, process 1000 may include, for each beam direction of a plurality of specified beam directions, obtaining in-band TRP measurements of the respective beam in the RC (block 1020). For example, the UE (e.g., using communication manager 1206 and reception component 1202, depicted in FIG. 12) may, for each beam direction of a plurality of specified beam directions, obtain in-band TRP measurements of the respective beam in the RC, as described above.

Process 1000 may include additional aspects, such as any single aspect or any combination of aspects described below and/or in connection with one or more other processes described elsewhere herein.

In a first aspect, process 1000 includes transmitting a successful message based at least in part on the in-band TRP measurements for the plurality of specified beam directions satisfying an emission condition, or locking a beam in a peak EIRP direction in an anechoic chamber based at least in part on the in-band TRP measurements for the plurality of specified beam directions not satisfying the emission condition.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a device or an apparatus of a device, in accordance with the present disclosure. Example process 1100 is an example where the apparatus or the device (e.g., network node 110, testing device 130, device 510) performs operations associated with techniques for testing beams.

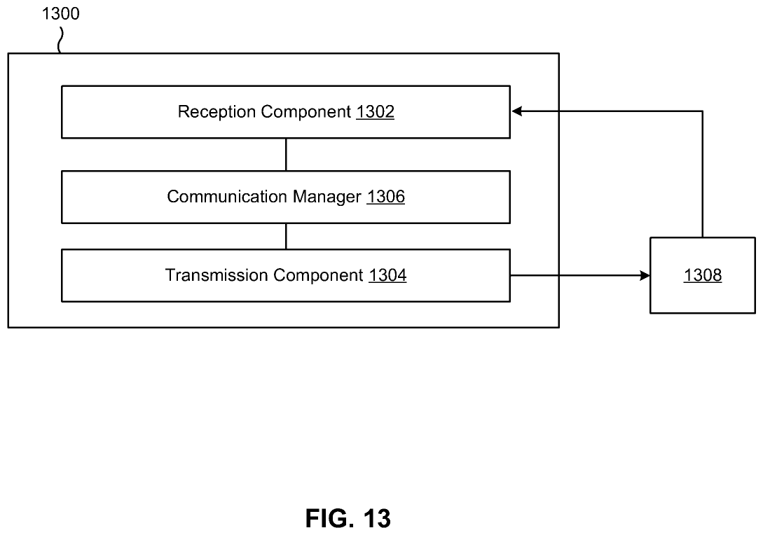

As shown in FIG. 11, in some aspects, process 1100 may include transmitting a first activation message to activate a beam lock in an AC (block 1110). For example, the device (e.g., using transmission component 1304 and/or communication manager 1306, depicted in FIG. 13) may transmit a first activation message to activate a beam lock in an AC, as described above.

As further shown in FIG. 11, in some aspects, process 1100 may include transmitting a request for a beam ID that is based at least in part on the beam lock (block 1120). For example, the device (e.g., using transmission component 1304 and/or communication manager 1306, depicted in FIG. 13) may transmit a request for a beam identifier (ID) that is based at least in part on the beam lock, as described above.

As further shown in FIG. 11, in some aspects, process 1100 may include receiving the beam ID (block 1130). For example, the device (e.g., using reception component 1302 and/or communication manager 1306, depicted in FIG. 13) may receive the beam ID, as described above.

Process 1100 may include additional aspects, such as any single aspect or any combination of aspects described below and/or in connection with one or more other processes described elsewhere herein.

In a first aspect, process 1100 includes receiving a completion message that indicates completion of the beam lock in the AC.

In a second aspect, alone or in combination with the first aspect, the one or more processors are individually or collectively configured to cause the network entity to transmit a second activation message to activate a beam lock at the beam ID in an RC.

In a third aspect, alone or in combination with one or more of the first and second aspects, the one or more processors are individually or collectively configured to receive a completion message that indicates completion of the beam lock in the RC.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120, UE 520), or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-7. Additionally, or alternatively, the apparatus 1200 may be configured to perform one or more processes described herein, such as process 800 of FIG. 8, process 900 of FIG. 9, process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

In some aspects, the reception component 1202 may receive a first activation message to activate a beam lock in an AC. The reception component 1202 may receive a request for a beam ID that is based at least in part on the beam lock. The transmission component 1204 may transmit the beam ID. The transmission component 1204 may transmit a completion message that indicates completion of the beam lock in the AC.

The reception component 1202 may receive a second activation message to activate a beam lock of a beam associated with the beam ID in an RC. The transmission component 1204 may transmit a completion message that indicates completion of the beam lock in the RC.

The communication manager 1206 may activate a beam lock in the AC. The reception component 1202 may obtain a peak EIRP direction in the AC. The communication manager 1206 may select the beam ID based at least in part on the EIRP direction. The reception component 1202 may obtain in-band TRP measurements in a direction of a beam associated with the beam ID. The reception component 1202 may obtain the beam ID based at least in part on signaling from a system simulator of the AC chamber.

In some aspects, the reception component 1202 may receive a first activation message to lock an antenna pattern that forms a beam towards an SS direction in an AC. The communication manager 1206 may lock a beam in a peak EIRP direction in the AC. The transmission component 1204 may transmit a first completion message that indicates completion of a beam lock in the AC. The communication manager 1206 may unlock the antenna pattern based at least in part on expiration of a timer.

The reception component 1202 may obtain in-band TRP measurements of the beam in the peak EIRP direction in the AC. The reception component 1202 may obtain in-band TRP measurements of a beam in a first direction in an RC.

In some aspects, the communication manager 1206 and the reception component 1202 may, for each beam direction of a plurality of specified beam directions, lock a respective beam in the direction in an RC and obtain in-band TRP measurements of the respective beam in the RC.

The transmission component 1204 may transmit a successful message based at least in part on the in-band TRP measurements for the plurality of specified beam directions satisfying an emission condition. The communication manager 1206 may lock a beam in a peak EIRP direction in an anechoic chamber based at least in part on the in-band TRP measurements for the plurality of specified beam directions not satisfying the emission condition.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network entity (e.g., network node 110, testing device 130, device 510), or a network entity may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 1-7. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network entity described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network entity described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network entity described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The transmission component 1304 may transmit a first activation message to activate a beam lock in an AC. The transmission component 1304 may transmit a request for a beam ID that is based at least in part on the beam lock. The reception component 1302 may receive the beam ID. The reception component 1302 may receive a completion message that indicates completion of the beam lock in the AC.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving a first activation message to activate a beam lock in an anechoic chamber (AC); receiving a request for a beam identifier (ID) that is based at least in part on the beam lock; and transmitting the beam ID.

Aspect 2: The method of Aspect 1, further comprising transmitting a completion message that indicates completion of the beam lock in the AC.

Aspect 3: The method of any of Aspects 1-2, further comprising receiving a second activation message to activate a beam lock of a beam associated with the beam ID in a reverberation chamber (RC).

Aspect 4: The method of Aspect 3, further comprising transmitting a completion message that indicates completion of the beam lock in the RC.

Aspect 5: The method of any of Aspects 1-4, further comprising activating a beam lock in the AC.

Aspect 6: The method of Aspect 5, further comprising: obtaining a peak effective isotropic radiated power (EIRP) direction in the AC; and selecting the beam ID based at least in part on the EIRP direction.

Aspect 7: The method of any of Aspects 1-6, further comprising obtaining in-band transmit receive point (TRP) measurements in a direction of a beam associated with the beam ID.

Aspect 8: The method of any of Aspects 1-7, further comprising obtaining the beam ID based at least in part on signaling from a system simulator of the AC chamber.

Aspect 9: The method of any of Aspects 1-8, wherein the AC includes a direct far field (DFF) chamber or an indirect far field (IFF) chamber.

Aspect 10: A method for wireless communication by user equipment (UE), comprising: receiving a first activation message to lock an antenna pattern that forms a beam towards a system simulator (SS) direction in an anechoic chamber (AC); and locking a beam in a peak effective isotropic radiated power (EIRP) direction in the AC.

Aspect 11: The method of Aspect 10, wherein the AC includes a direct far field (DFF) chamber or an indirect far field (IFF) chamber.

Aspect 12: The method of any of Aspects 10-11, further comprising transmitting a first completion message that indicates completion of a beam lock in the AC.

Aspect 13: The method of any of Aspects 10-12, further comprising unlocking the antenna pattern based at least in part on expiration of a timer.

Aspect 14: The method of any of Aspects 10-13, further comprising obtaining in-band transmit receive point (TRP) measurements of the beam in the peak EIRP direction in the AC.

Aspect 15: The method of Aspect 14, further comprising obtaining in-band TRP measurements of a beam in a first direction in a reverberation chamber (RC).

Aspect 16: The method of Aspect 15, wherein the one or more processors are individually or collectively configured to cause the UE to: perform additional testing in the first direction in the RC based at least in part on a difference between a power measurement in the peak EIRP direction and a power measurement in the first direction satisfying a difference threshold; or obtain in-band TRP measurements of a beam in a second direction in the RC based at least in part on the difference not satisfying the difference threshold.

Aspect 17: A method of wireless communication performed by a user equipment (UE), comprising: for each beam direction of a plurality of specified beam directions, locking a respective beam in the direction in a reverberation chamber (RC); and obtaining in-band transmit receive point (TRP) measurements of the respective beam in the RC.

Aspect 18: The method of Aspect 17, further comprising: transmitting a successful message based at least in part on the in-band TRP measurements for the plurality of specified beam directions satisfying an emission condition, or locking a beam in a peak effective isotropic radiated power (EIRP) direction in an anechoic chamber based at least in part on the in-band TRP measurements for the plurality of specified beam directions not satisfying the emission condition.

Aspect 19: A method of wireless communication performed by a device, comprising: transmitting a first activation message to activate a beam lock in an anechoic chamber (AC); transmitting a request for a beam identifier (ID) that is based at least in part on the beam lock; and receiving the beam ID.

Aspect 20: The method of Aspect 19, further comprising receiving a completion message that indicates completion of the beam lock in the AC.

Aspect 21: The method of any of Aspects 19-20, wherein the one or more processors are individually or collectively configured to cause the network entity to transmit a second activation message to activate a beam lock at the beam ID in a reverberation chamber (RC).

Aspect 22: The method of Aspect 21, wherein the one or more processors are individually or collectively configured to receive a completion message that indicates completion of the beam lock in the RC.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
one or more memories; and
one or more processors, coupled to the one or more memories, individually or collectively configured to cause the UE to:
receive a first activation message to activate a beam lock in an anechoic chamber (AC);
receive a request for a beam identifier (ID) that is based at least in part on the beam lock; and
transmit the beam ID.

2. The UE of claim 1, wherein the one or more processors are individually or collectively configured to cause the UE to transmit a completion message that indicates completion of the beam lock in the AC.

3. The UE of claim 1, wherein the one or more processors are individually or collectively configured to cause the UE to receive a second activation message to activate a beam lock of a beam associated with the beam ID in a reverberation chamber (RC).

4. The UE of claim 3, wherein the one or more processors are individually or collectively configured to cause the UE to transmit a completion message that indicates completion of the beam lock in the RC.

5. The UE of claim 1, wherein the one or more processors are individually or collectively configured to cause the UE to activate a beam lock in the AC.

6. The UE of claim 5, wherein the one or more processors, to activate the beam lock in the AC, are individually or collectively configured to cause the UE to:
obtain a peak effective isotropic radiated power (EIRP) direction in the AC; and
select the beam ID based at least in part on the EIRP direction.

7. The UE of claim 1, wherein the one or more processors are individually or collectively configured to cause the UE to obtain in-band transmit receive point (TRP) measurements in a direction of a beam associated with the beam ID.

8. The UE of claim 1, wherein the one or more processors are configured to obtain the beam ID based at least in part on signaling from a system simulator of the AC chamber.

9. The UE of claim 1, wherein the AC includes a direct far field (DFF) chamber or an indirect far field (IFF) chamber.

10. A user equipment (UE) for wireless communication, comprising:
one or more memories; and
one or more processors, coupled to the one or more memories, individually or collectively configured to cause the UE to:
receive a first activation message to lock an antenna pattern that forms a beam towards a system simulator (SS) direction in an anechoic chamber (AC); and
lock a beam in a peak effective isotropic radiated power (EIRP) direction in the AC.

11. The UE of claim 10, wherein the AC includes a direct far field (DFF) chamber or an indirect far field (IFF) chamber.

12. The UE of claim 10, wherein the one or more processors are individually or collectively configured to cause the UE to transmit a completion message that indicates completion of a beam lock in the AC.

13. The UE of claim 10, wherein the one or more processors are individually or collectively configured to cause the UE to unlock the antenna pattern based at least in part on expiration of a timer.

14. The UE of claim 10, wherein the one or more processors are individually or collectively configured to cause the UE to obtain in-band transmit receive point (TRP) measurements of the beam in the peak EIRP direction in the AC.

15. The UE of claim 14, wherein the one or more processors are individually or collectively configured to cause the UE to obtain in-band TRP measurements of a beam in a first direction in a reverberation chamber (RC).

16. The UE of claim 15, wherein the one or more processors are individually or collectively configured to cause the UE to:
perform additional testing in the first direction in the RC based at least in part on a difference between a power measurement in the peak EIRP direction and a power measurement in the first direction satisfying a difference threshold; or
obtain in-band TRP measurements of a beam in a second direction in the RC based at least in part on the difference not satisfying the difference threshold.

17. A user equipment (UE) for wireless communication, comprising:
one or more memories; and
one or more processors, coupled to the one or more memories, individually or collectively configured to cause the UE to:
for each beam direction of a plurality of specified beam directions,
lock a respective beam in the direction in a reverberation chamber (RC); and
obtain in-band transmit receive point (TRP) measurements of the respective beam in the RC.

18. The UE of claim 17, wherein the one or more processors are individually or collectively configured to cause the UE to:
transmit a successful message based at least in part on the in-band TRP measurements for the plurality of specified beam directions satisfying an emission condition, or
lock a beam in a peak effective isotropic radiated power (EIRP) direction in an anechoic chamber based at least in part on the in-band TRP measurements for the plurality of specified beam directions not satisfying the emission condition.

19-30. (canceled)
